(19) United States
(12) Patent Application Publication
(10) Pub. No.: US 2009/0292547 A1
(43) Pub. Date: Nov. 26, 2009

(54) Auction Trading Interface

(75) Inventor: Magnus Lenti, Solna (SE)

Correspondence Address: POTOMAC PATENT GROUP PLLC, P. O. BOX 270, FREDERICKSBURG, VA, 22404, US

(73) Assignee: CINNOBER FINANCIAL TECHNOLOGY AB, Stockholm (SE)

(21) Appl. No.: 12/124,898

(22) Filed: May 21, 2008

(51) Int. Cl. G06Q 99/00

(52) U.S. Cl. 705/1

(57) ABSTRACT

In an auction order display, the market is displayed on a screen where bids and offers are displayed along two lines. The corresponding bid and offer prices are, for example, in two columns, with the offer and bid columns displayed side by side, and the corresponding bid and offer prices aligned. In that way, a trader can instantly get a view of the current market, and decisions can be made more quickly.

### BACKGROUND

The present invention relates to a method and a system for trading financial instruments. In particular, the present invention relates to an efficient method and system for trading financial instruments in an auction.

In a financial market, some financial instruments are traded in an auction. An auction in a financial market can typically be performed thusly:
bids and offers are received during a time period;
upon expiration of the time period, matching bids and offers are matched; and
matched orders are traded between the parties who submitted the bids and offers.

Today, most trading in financial markets is facilitated by automated electronic trading systems. Electronic trading is performed in trade stocks, bonds, futures, options, and other products. These electronic exchanges typically comprise three major parts: host computer servers, exchange participants' computers, and communications servers interconnecting the host servers and the participant computer systems.

The participant computer can follow the activities on the central servers of the automated electronic exchange system via a visual interface, typically a display screen. The information displayed on the screen is used to keep the market participant informed about the market of interest, and also to aid one when placing orders in the market.

In a typical market, many trading activities can take place within a short time frame. In turn, this puts a demand on the person following the market via a visual display. A particular movement in the market may cause a trader to perform certain activities. Such activities will have to take place quickly. It is therefore imperative that the visual display displays the information in a manner that can be interpreted quickly, and which thereby enables a trader to act quickly in response to a new market situation. A particular new situation may, for example, cause a trader to place a bid or an offer in the relevant market. Such an order can typically be placed by entering an order into a system using a keypad, or by clicking on a screen using a pointing device such as a computer mouse, or by using a combination of these methods.

Hence, there exists a need for a method and a system that enables an automated trading system to display the market in a manner that enables a trader to quickly get a view of the current market situation.

### SUMMARY

This invention can overcome or at least reduce some of the problems associated with existing automated trading system displays. Methods and systems are provided that are capable of displaying an auction market, i.e., a market with potentially crossing prices for bids and offers in an electronic automated exchange system, in a way that enables a trader to quickly get a view of the market situation. A trader can enter orders more quickly and with higher accuracy.

Methods and systems in accordance with this invention are set out in the appended claims. In brief, by displaying an auction order market on a screen where bids and offers are displayed in two lines side by side, with the corresponding bid and offer prices aligned, a trader can instantly get a view of the current market, whereby decisions can be made more quickly.

Using the methods and systems in accordance with this invention will provide an automated trading system that is more user-friendly, and which enables users to quickly read a present market situation.

### BRIEF DESCRIPTION OF THE DRAWINGS

This invention will now be described in more detail by way of non-limiting examples, and with reference to the accompanying drawings, in which:

FIG. 1 is a view of an automated trading system,

FIG. 2 is a view of a screen used for auction trading,

FIG. 3 is a view of a screen used for auction trading in accordance with one embodiment of the present invention, and

FIG. 4 is a flowchart illustrating steps performed by a computer when displaying a bid/offer on a display.

### DETAILED DESCRIPTION

In FIG. 1, a view illustrating an automated trading system 100 is shown. The system 100 is configured to host an electronic auction market. The automated trading system 100 further comprises a trading module 101 for receiving order from various trading parties 103 such as banks, brokers, individual traders, and the like, connected to the automated trading system 100 for placing orders therein. The trading module 101 of the system 100 has a matching module 105, which acts as a controller unit and matches orders, and a memory 107, arranged as an orderbook where orders can be stored.

A trading party 103 can typically be a workstation having a user interface, such as a display screen 109, and one or more input devices 111 such as a keypad and or a computer mouse. Using the input device 111, a trading party can place orders into and/or remove orders from the trading system 100. A decision to submit or withdraw orders from the market is, at least partly, based on the situation in the market as displayed on the screen 109.

In an electronic market place of today, much information is processed at high speed. The result is that the market changes very quickly indeed. It is therefore important to display market information to a trading party in a condensed and user-friendly manner, so that a trading party can easily can access the displayed information and act accordingly.

One type of market is a market where the system, during a time period, receives bids and offers for a particular type of financial instrument or the like. Upon expiration of that time period, the system closes the market and matches crossing and matched bids and offers. This is usually termed an auction market. Typically, all bids and offers are matched at the same price, which is calculated by the system based on the received bids and offers. For example, the price at which bids and offers are matched can be calculated as the price at which the most volume of orders is matched. Other methods for matching orders in an auction market include matching at a price generating the highest revenue, or a price where the largest orders are matched. In addition, other methods exist for calculating the price at which the bids and offers are matched. During the time frame when bids and offers can be submitted, the submitted bids and offers can either be displayed openly or kept secret by the system.

If the submitted orders are displayed, they should be displayed so that a user easily can get a view of the market; this facilitates the decision of whether to submit an order to the auction market, and, if so, at what price. The information may also be used as a basis for cancelling an order already submitted, if the system allows for such an action.

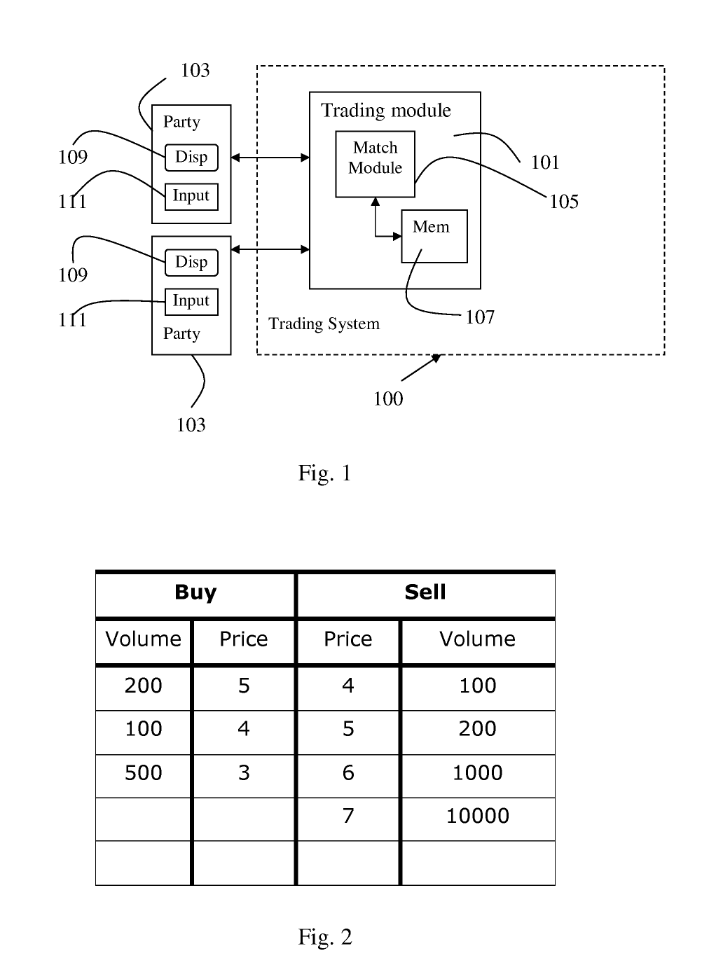

In FIG. 2, a view of a conventional orderbook for displaying bids and offers in an auction market is shown. The display shows all bids, such that the best bid and offer is placed at the top row; the second-best price for bids and offers, in the second row; etc.

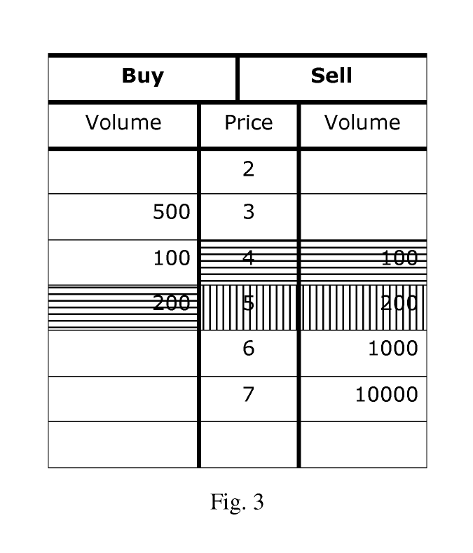

FIG. 3 shows a view of an auction order display in accordance with a preferred embodiment of the present invention. In FIG. 3, the system is configured to perform an auction for lending of stocks. The display shows submitted orders in two columns. The orders in the first column are offers to sell. In this example, the offer is to lend a particular stock, and the orders in the second column are bids to buy, again in this example the bid is for lending of a particular stock.

In accordance with one embodiment of the present invention, the offer column and the bid column are displayed side by side, with the corresponding bid and offer prices aligned in the same rows. In accordance with another embodiment, the corresponding bids and offer prices are placed on top of each other, and the display shows the submitted orders aligned along a row. Hence, an offer at $2 is displayed side by side with, e.g., in the same row as, a bid at $2. Furthermore, all bids and offers are sorted by price on the display: the higher price, the further up or down it will be along the line where the order is displayed. In the example in FIG. 3, the lowest price is placed in the top row with the orders placed in two columns.

To further assist a trading party, each order that would trade if the market were to close now is marked on the display by a particular visual indicator. For example, a green dot can be used as the visual indicator, or the entire cell can be colored in a particular color such as green, but any suitable visual indicator may, of course, be used. In FIG. 3, matching orders are marked with horizontal hatching. Also, in a preferred embodiment, the price at which the matching will take place is marked in the same way using the same visual indicator, or a visual indicator different from the visual indicator marking the trading orders. In addition, another visual indicator can be used to identify the orders that have a price that would be matched if sufficient volume was available at the other side of the market. For example, a yellow dot can be used as the visual indicator, or vertical hatching, as in some of the cells in FIG. 3. Again any suitable type of visual indication may be used.

For example, consider an auction market where the current matching price is $2; there are 4,000 contracts on the offer side at a price of $2 or better; and there are 3,000 contracts on the bid side at a price of $2 or better. In such a scenario, 3,000 contracts could be matched if the auction were held now, and another 1,000 contracts could have been matched had there been 1,000 or more bids at $2 or better. The 1,000 contracts that could have been matched are labeled with the visual indicator.

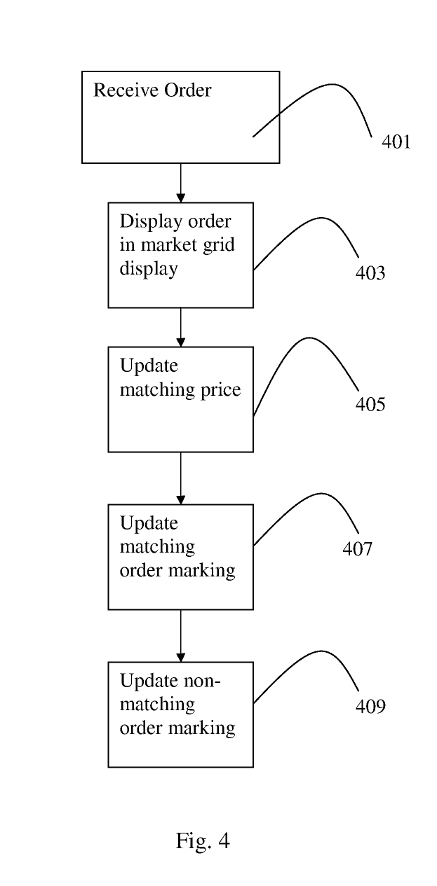

FIG. 4 shows a flowchart illustrating the steps performed in accordance with one embodiment, when displaying orders in an auction market on a trading screen of a computerized trading system. First, in a step 401, an order input is received. Next, in a step 403, the order is displayed with size and price in a grid. As shown in FIG. 3, the grid has offer and bid columns displayed side by side with the corresponding bid and offer prices aligned in the same rows. The price at which bids and orders are matched is updated in a step 405. In a step 407, the orders currently being matched are marked accordingly. The orders within the price to be matched—but for which there are too few contracts on the other side to complete a trade—are also marked accordingly in a step 409. The display procedure then returns to step 401, to await a new order entry.

Using the method and device as described herein will provide a more user-friendly display of an auction market. The display will give a trading party a comprehensive overview of an auction market, which will, in turn, assist in placing bids and offers in the auction market.

1. A method in a processor system of displaying bids and offers of an auction market on an electronic display in communication with the computer system, the method comprising the steps of:
the system's displaying bids of the auction market along a first line on the display, sorted by price, wherein the auction market comprises:
bids and offers being received during a time period;
upon expiration of the time period, matching bids and offers are matched: and
matched orders are traded between the parties who submitted the bids and offers;
the system's displaying offers of the auction market along a second line on the display sorted by price; and
the system's displaying the first and second line side by side with corresponding prices in alignment with each other on the display.

2. The method of claim 1, wherein the system marks by a first visual indicator on the display each order that trades when the market closes at a present time.

3. The method of claim 2, wherein the first visual indicator corresponds to a color field occupying at least part of a field where the trading orders are displayed.

4. The method of claim 1, wherein the system marks by a second visual indicator on the display each order that is matched when sufficient volume is available at the other side of the market.

5. The method of claim 1, wherein a price at which trading would take place at a particular moment is marked with a visual indicator.

6. The method of claim 2, wherein a price at which trading would take place at a particular moment is marked with the first visual indicator.

7. The method of claim 1, wherein the first line and the second line correspond to rows or columns.

8. A system for displaying bids and offers of an auction market on an electronic display comprising:
means for displaying bids of the auction market along a first line sorted by price, wherein the auction market comprises:
bids and offers being received during a time period:
upon expiration of the time period, matching bids and offers are matched: and
matched orders are traded between the parties who submitted the bids and offers;
means for displaying offers of the action market along a second line sorted by price; and
means for displaying the first and second line side by side with corresponding prices in alignment with each other.

9. The system of claim 8, wherein each order that trades when the market closes at a present time is marked on the display by a first visual indicator.

10. The system of claim 9, wherein the first visual indicator corresponds to a color field occupying at least part of a field where the trading orders are displayed.

11. The system of claim 8, wherein each order that is matched when sufficient volume is available at the other side of the market is marked with a second visual indicator.

12. The system of claim 8, wherein a price at which trading would take place at a particular moment is marked with a visual indicator.

13. The system of claim 9, wherein a price at which trading would take place at a particular moment is marked with the first visual indicator.

14. The system of claim 8, wherein the first line and the second line correspond to rows or columns.

15. A computer-readable medium having stored instructions that, when executed by a computer, cause the computer to implement an electronic user interface for displaying bids and offers of an auction market, wherein the electronic user interface comprises:
a first line displaying bids of the auction market sorted by price, wherein the auction market comprises:
bids and offers being received during a time period:
upon expiration of the time period, matching bids and offers are matched: and
matched orders are traded between the parties who submitted the bids and offers; and
a second line displaying offers of the action market sorted by price;
wherein the first and second lines are displayed side by side with corresponding prices in alignment with each other.

16. The user interface of claim 15, wherein each order that trades when the market closes at a present time is marked by a first visual indicator.

17. The user interface of claim 16, wherein the first visual indicator corresponds to a color field occupying at least part of a field displaying the trading orders.

18. The user interface of claim 15, wherein each order that is matched when sufficient volume is available at the other side of the market is marked with a second visual indicator.

19. The user interface of claim 15, wherein a price at which trading would take place at a particular moment is marked with a visual indicator.

20. The user interface of claim 16, wherein a price at which trading would take place at a particular moment is marked with the first visual indicator.

21. The user interface of claim 15, wherein the first line and second lines correspond to rows or columns.
